(19) United States
(12) Patent Application Publication
(10) Pub. No.: US 2007/0196541 A1
(43) Pub. Date: Aug. 23, 2007

(54) Domed food container system

(75) Inventors: Terry Vovan, Rialto, CA (US); Dean Brown, Beaverton, MI (US)

Correspondence Address: Terrance Mason, 12349 Milbank Street, Studio City, CA, 91604, US

(73) Assignee: PWP Industries

(21) Appl. No.: 11/358,617

(22) Filed: Feb. 21, 2006

(51) Int. Cl. A23B 7/148

(52) U.S. Cl. 426/106

(57) ABSTRACT

A rigid polymer domed food container system suitable for heated food products is described. Recessed vents in the lid of the food container systems permit stacking of multiple container systems while allowing heated gases to escape without restriction. Other features of this container system include the retention of food product within the central region of the tray, rigidized handholds to allow the consumer to lift the heated container, and a releaseably lockable snap-fit grip mechanism that facilitates opening of the container system among other things.

### FIELD OF THE INVENTION

The present invention relates to container system configurations for foodstuff. More particularly, the invention relates to a food packaging containment system that is suitable for heated food items such as rotisserie chicken and the like, and includes a tray compartment and a lid member. The container system preferably includes tamper-resistant features, as well as tamper-evident features that visually evidence unauthorized ingress if interfered either inadvertently or with the intent to cause harm.

### BACKGROUND OF THE INVENTION

Retail markets have utilized rigid and flexible plastic containers to protect and display both perishable and fragile food items such as sandwiches, salads and bakery items. These traditional roles of plastic packaging are now the minimum expected standards, and the requirements placed on plastic food packaging continue to expand as increasing demands are placed upon it. Presentation, brand presence, consumer desires, added value to enhance commercial competitiveness, differentiation, imagery and psychology has resulted in the design and application of plastic packaging becoming more challenging. Convenience and versatility continue to shape the future of packaging, with consumers gravitating toward packaged convenience items that minimize the impact on their behavior. This has forced packaging manufacturers to include social and environmental considerations into their development process. The provision of multiple compartments in a variety of shapes and utilities in rigid plastic containers has been one such direction that packaging manufacturers have been pursuing.

Rigid plastic food containers are typically manufactured from Polystyrene, Polypropylene, Polyethylene Terephthalate (PET), Polylactide, Polyvinyl Chloride (PVC), or other rigid polymers. They generally comprise either of two-parts—a tray and lid—or they may be a one-piece construction with a hinge that modifies one portion of the container to act as the tray and the other connected portion to act as a lid. Furthermore, they are available in a variety of shapes and cross-sections—circular, rectangular, square, and elliptical, etc.

The use of such plastics for holding heated food has gained favor with the rotisserie chicken being one of the fastest growing applications. However, many currently available food packages have not been designed to cater to the consumer's needs as related to the handling of such container systems for heated foods. Heating of the container contents result in high temperature fluids and gases result in increased pressure build-up, can be painful to the touch. Such constraints also place limitations on the logistical elements such as containerization of large quantities of heated food product. This invention provides for a unique approach that achieves this objective.

### SUMMARY OF THE INVENTION

In a preferred embodiment of the invention, the tray and lid members of the container system possess edges that are designed to mate with and be releaseably lockable to each other. The releaseably lockable mechanism is usually accomplished using a snap-fit grip and the elements comprising the releaseably lockable snap-fit grip enable a force fit between the lid member and the tray member of the container system. In this embodiment, the releaseably lockable mechanism is further designed to have a uniform cross-section along its entire periphery and is specially configured to hinder condensate from escaping at the lid-tray interface.

In another embodiment of the invention, opposing sides of the lid and tray members are extended to act as handholds to help the consumer lift the heated container system. Generally, markets that offer heated food products such as rotisserie chickens in plastic container system either provide gloves for the consumer to handle the heated package or the heated package is placed in a cardboard lifting cradle with a handle that resides over the top of the lid member of the container system. This embodiment of the present invention eliminates the need for such devices and additionally enables the food manufacturer and retailer to stack the container systems.

Without venting, expansion of the container as a consequence of heated gases including steam would cause the lid to pop from the tray member. Vents permit the release of these trapped vapors. In another embodiment of the invention, the vents are recessed into the top of the lid member. The recessed vents serve to permit stacking of the containers without blocking of the vents, thus allowing the food retailer additional space savings while maintaining the display effectiveness of the container system.

In another embodiment of the invention, the lid of the container system is secured to the tray by means of a tamper-evident tamper-resistant snap-fit grip mechanism. Rigid plastic tamper-evident packaging generally provide visible-to-the-naked-eye indication that a container has been interfered with, that is, it had previously be opened and then re-closed prior to purchase. This invention is a novel plastic packaging solution that improves significantly on the convenience and therefore marketability of food product.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an isometric view of an embodiment of the present invention showing the disassembled lid and tray members.

FIG. 2 is a plan view of the container system in FIG. 1.

FIG. 3 is a plan view of the bottom of the tray member in FIG. 2.

FIG. 4 is an enlarged perspective view of a recessed vent depicted in FIG. 1.

FIG. 5 is a side view of the assembled container system in FIG. 1.

FIG. 6 is an enlarged cross-sectional view of the releaseably locking mechanism and handle of the container system in taken in the 5-5 plane in FIG. 2.

FIG. 7 is a side view of an embodiment of the present invention.

FIG. 8 is a cross-sectional view of the container systems in FIG. 2 taken along the line 7-7 in FIG. 2.

FIG. 9 is a fragmentary sectional view of the releaseably locking mechanism of the container system taken in the Y-Y plane of FIG. 8.

FIG. 10 is a fragmentary sectional view of a portion of the tray member of the container system taken in the Z-Z plane of FIG. 8.

FIG. 11 is cross-sectional view of two container systems each similar to that depicted in FIG. 8 illustrating how the food container systems is stacked.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiments set forth herein; rather, this embodiment is provided so that this disclosure will be thorough and complete and will fully convey the scope of the invention to those skilled in the art.

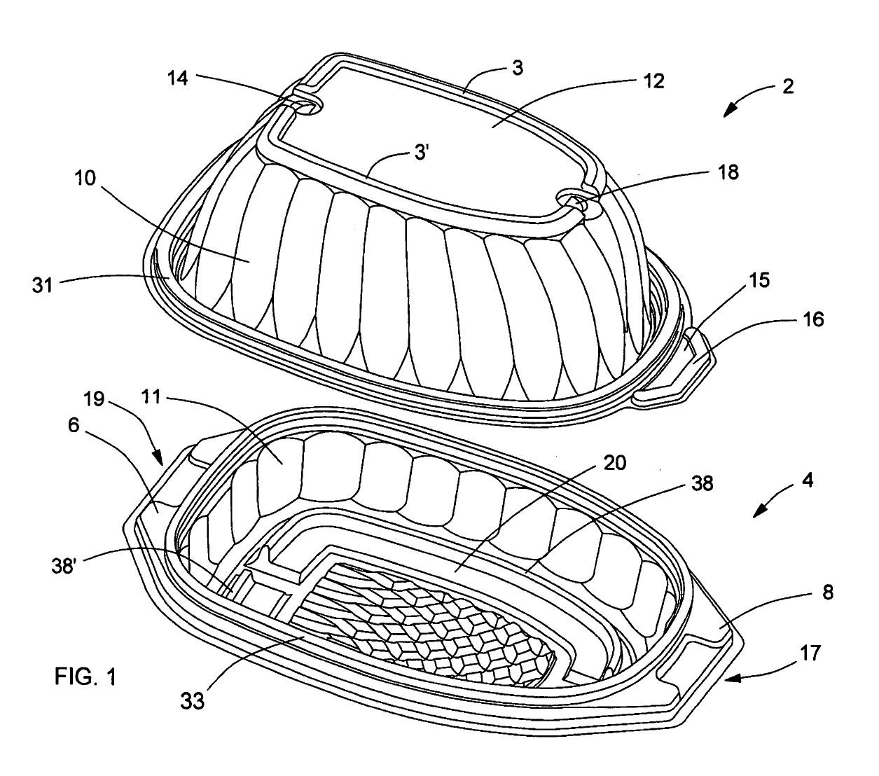

Referring to the drawings and in particular to FIGS. 1 & 2, there is shown a dome-shaped, rigid polymer construct food container system according to the present invention. The food container system includes a lid member 2 and tray member 4 which forms the primary recess into which heated foodstuff, such as a rotisserie chicken, is placed.

The lid and tray members 2, 4 of the container system can be molded, through known thermoforming manufacturing means, from a single sheetline of polymer material work piece into a predetermined shape and thickness as required. The lid and tray members 2, 4 of the container system may also be formed, through known thermoforming manufacturing means, into a curvilinear geometry to thereby provide the end user with a variety of polygonal shapes. In the container system of the invention, the lid member 2 has geometry that permits even mating with the tray member 4 at their peripheral edge. Additionally, mating between lid member 2 and tray member 4 is releaseably lockable and achieved using a snap-fit grip 25. As shown, the releaseably lockable mechanism is a slotable mechanical interface wherein the tray member snap-fit grip component 33 is the male element and the lid member snap-fit grip component 31 is the female element. Rib element 16 increases the rigidity and strength of the in the lid member handhold 15. Separating the lid member 2 from the tray member 4 is facilitated by pulling the lid member handhold 15 away from the tray member handhold 17. Also shown are raised ribbed sidewalls 10, 11 in the lid and tray members that improve the overall rigidity of the container system.

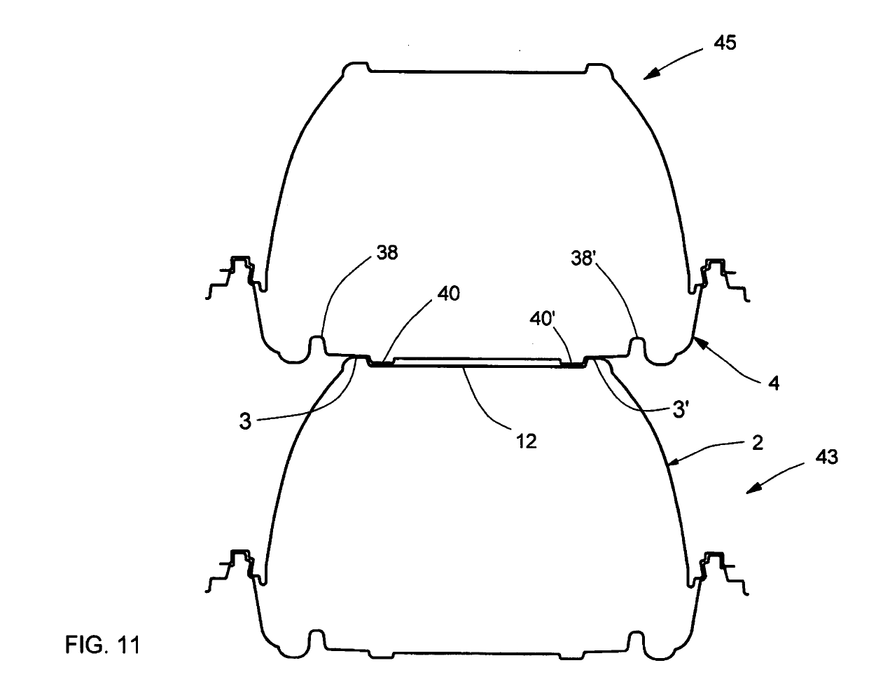

Also shown is the planar surface 12 of the lid member 2 that is bordered by a raised rib periphery 3, 3′ with the raised rib periphery 3, 3′ separated at their ends by recessed vents 14, 18. In addition to improving the structural integrity of the lid member, the raised rib periphery 3, 3′ serves to hold in place the tray member 4 of a second identical container system that may be stacked on the lid member 2. This feature is illustrated in greater detail in FIG. 11. The lid member 2 may be made from material that are dissimilar from the material used to make the tray member 4 so that when temperatures are elevated, dissimilar coefficients of thermal expansion of the lid member 2 and the tray member 4 increase the effectiveness of the mechanically fastening of the releaseably lockable snap-fit grip and thereby promote the retention of heated gases and condensate. The raised retaining ribs 38, 38′ is designed restrict movement of the food product contents generally so that they stay within the central portion of the tray member 4.

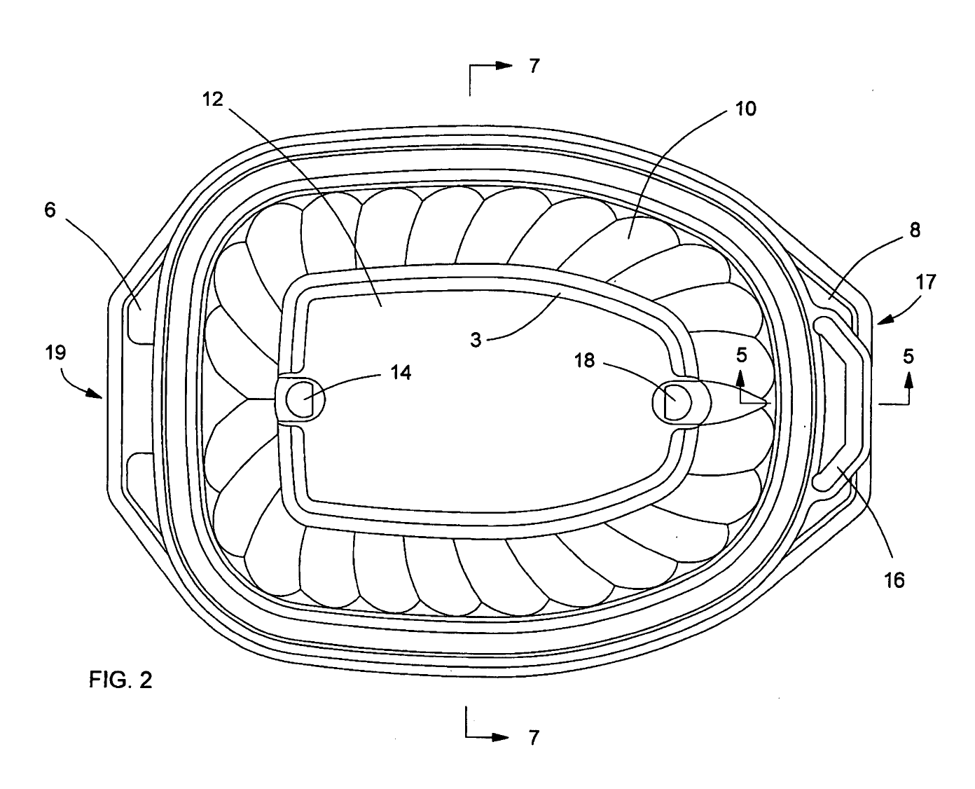

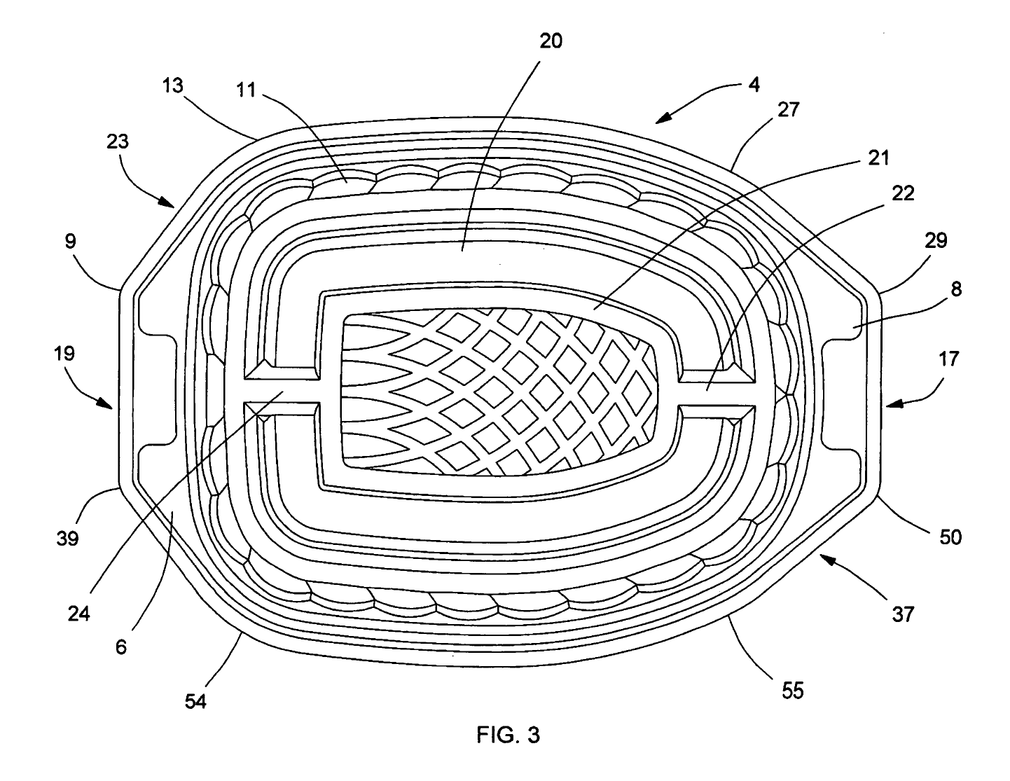

FIG. 3 further illustrates the complementary female grooved elements 21, 22 & 24 that form a mechanical fit with the raised rib 3 of the lid member 2. The female grooved element 21 sitting on the lid member planar surface 12 is illustrated in FIG. 2. The female grooved elements 22, 24 are straddled by the raised rib periphery 3, 3′ and sit above but are not in mechanical contact with the recessed vents 14, 18.

The extended flange lip 23 of the tray member is defined by the points 13 and 54, and extending outwards to points 9 and 39, and raised rib 6, together form the tray member handhold 19. Similarly, the extended flange lip 37 of the tray member defined by the points 27 and 55, and extending outwards to points 29 and 50, and raised rib 8, together form the tray member handhold 17. This design significantly increases the rigidity and the strength of the handholds 17 and 19 of the tray member 4. Together with the lid member handhold 15, tray member handholds 17, 19 give the consumer increased control when both lifting and opening the heated container system.

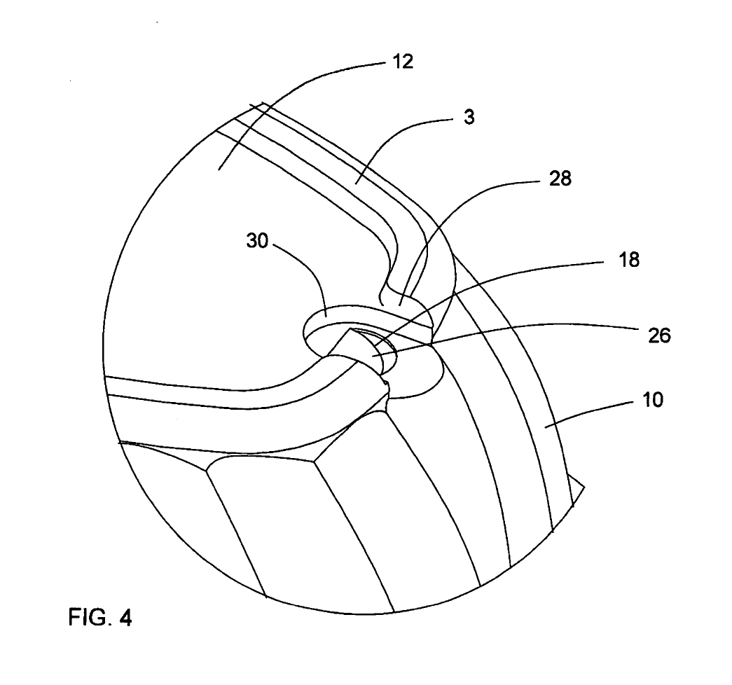

Turning to FIG. 4, shown therein is a fragmentary enlarged view of the recessed vent 18 of the present invention. The recessed vent 18 is straddled by the raised edge 28 of the raised rib periphery 3 and the raised edge 30 that leads to the planar surface 12 of the lid member 2. For illustrative purposes, venting means is achieved through the flap 26 comprising the recessed vent 18; however, any suitable perforation large enough to permit hot gas to pass through would suffice.

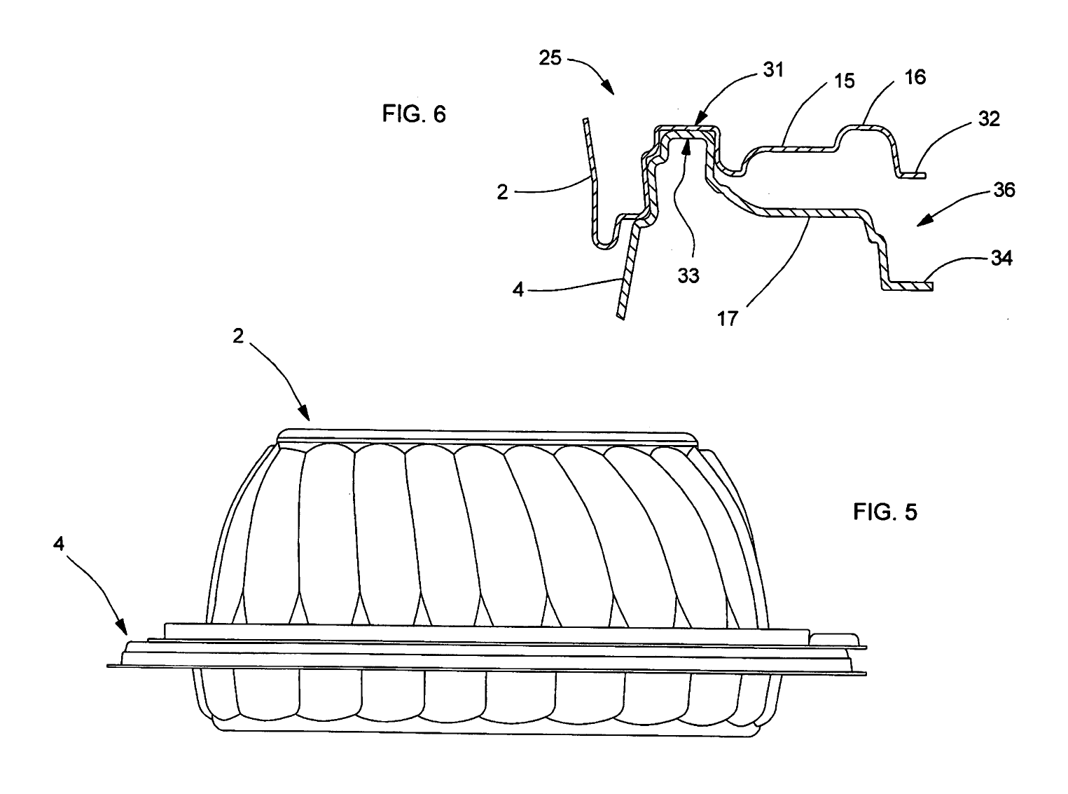

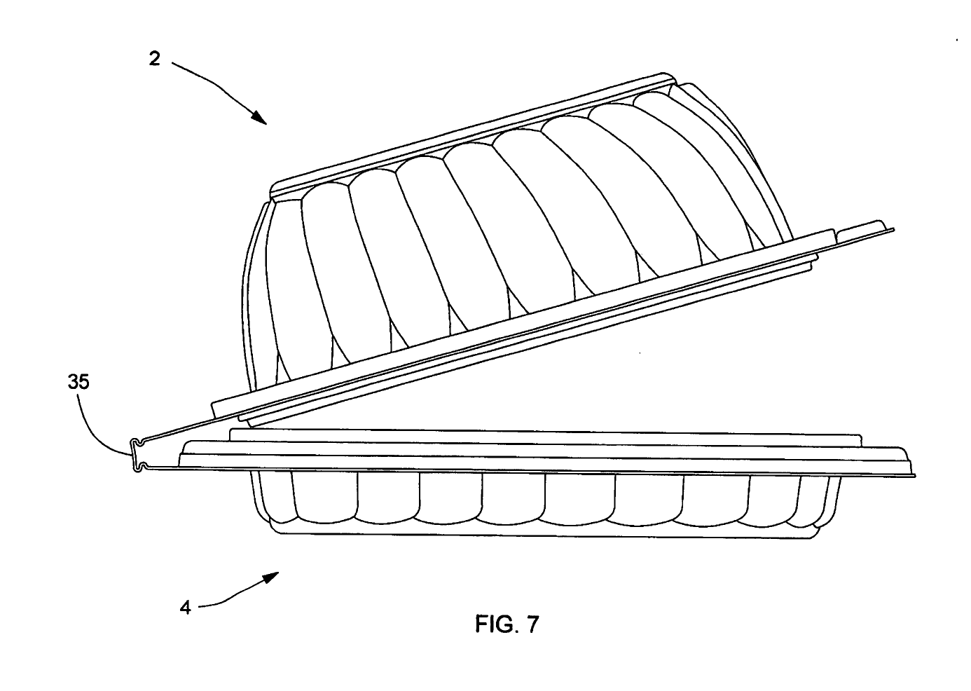

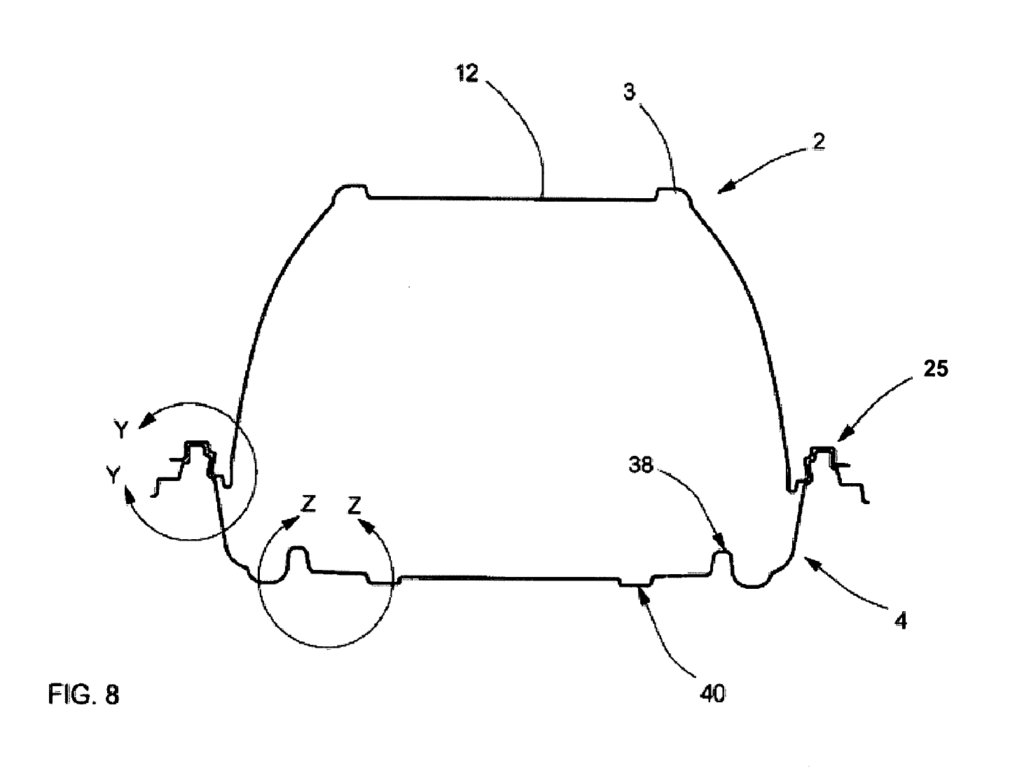

Turning to FIGS. 5 and 6, therein is shown a side view of the embodiment of present invention in FIG. 1 and the enlarged fragmentary cross-section of the lid and tray members' handhold elements 15, 17. Also shown is the releaseably lockable snap-fit grip mechanism 25 that secures the lid member 2 and tray member 4 together when the container system is assembled. The raised rib element 16 ends on an flat edge 32 that is vertically displaced from tray member edge 34 to facilitate gripping by fingers and further provides a gap 36 to allow the consumer to pry open and separate the lid member 2 from the tray member 4.

Turning to FIG. 7, therein is shown a side view of a variation of the embodiment of the present invention as in FIG. 1. As shown, the container system is a single piece construction with its lid member 2 and tray member 4 hingeably attached with a hinge 35.

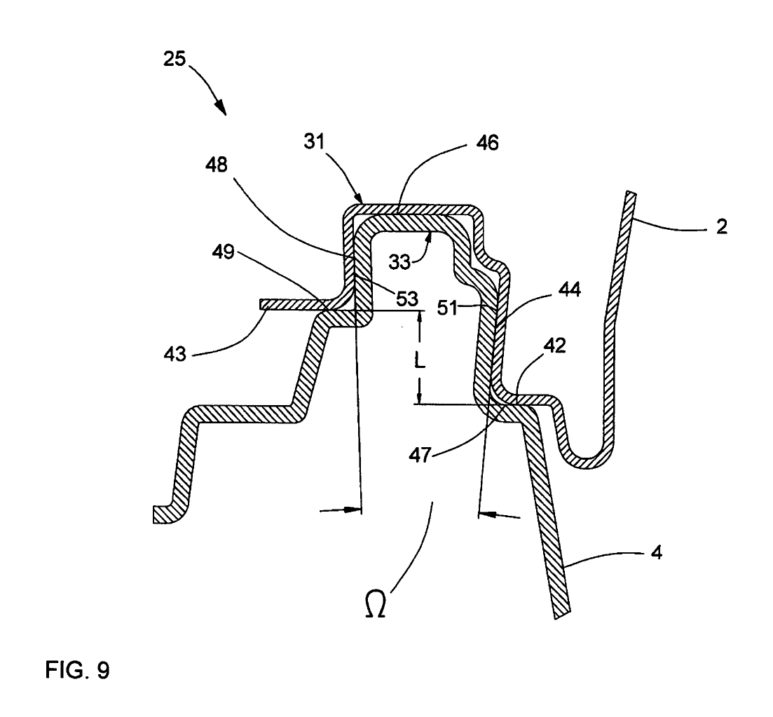

Turning now to FIG. 9, therein is shown an enlarged cross-sectional view of the releaseably lockable snap-fit grip 25 of the present invention. The elements comprising the releaseably lockable snap-fit grip 25 are integral parts of the lid member 2 and tray member 4, wherein the tray member snap-fit grip component 33 is the male element that slots into the female lid member snap-fit grip component 35 element. Improved retention of the fluids and hot gases is achieved by the five choke points 42, 44, 46, 48 & 49. The choke points serve to hinder the passage of fluids or gases from the interior of the container system. The planar surface 51 lying between choke points 42 and 46 but coincident with choke point 44, and the planar surface 53 lying between choke points 46 and 49 but coincident with choke point 48 are angled relative to each other making a concave with angle Ω between the two surfaces such that a tight fit is achieved. Edges 47 and 49 of the tray member 4 are incident with the choke points 42 and 49, and as shown, the edges are vertically displaced by a distance L, wherein the interior edge 47 is lower relative to the exterior edge 49. In order to remove the lid member 2 from the tray member 4, the lid edge 43 is lifted up. The differential ledge height L serves to facilitate the opening of the container system by permitting the lid member element of the snap-fit grip to pivot about the ledge 47.

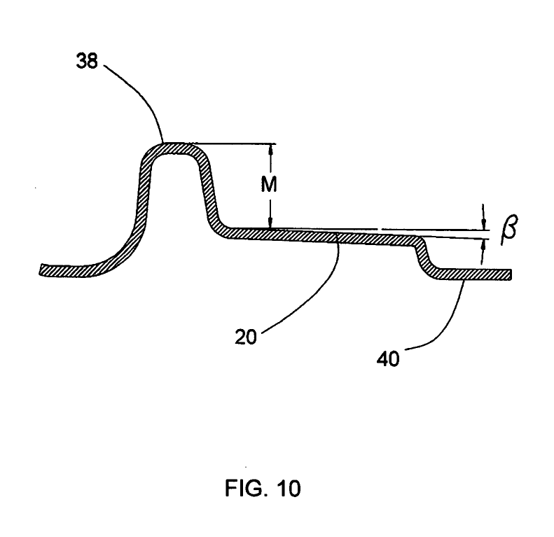

Turning now to FIG. 10, therein is shown an enlarged cross-sectional view of a portion of the tray member 4 illustrating the raised rib edge 38 that is located in the interior near the periphery of the tray member 4. The raised ribs 38, 38′ as shown in FIG. 1 is designed encourage the food product to remain within the central portion of the tray 4. The greater the height M of the raised rib edge 38, the greater its ability to encourage the food product to remain within the central portion of the tray 4. The height of raised rib edge 38 is limited by the thermoforming or other manufacturing process used to produce the tray member 4.

Also shown in FIG. 10 is the sloped portion 20 of the tray member 4 lying between the raised rib edge 38 and the tray footing 40. The slope is at an angle β from the horizontal plane and is designed to encourage the hot condensate and other fluids to flow toward the tray footing 40. The sloped portion 20 of the tray member 4 is also identified in FIG. 1 and FIG. 3.

Turning finally to FIG. 11 therein is shown a cross-sectional view of a first container system 45 of the present invention that is stacked on top of a second container system 43 of the present invention. The first container system 45 is held in place by a mechanical fit between raised rib peripheries 3, 3′ of the lid member 2 of the second container system 43 into which the complementary raised ribs that form the foot 40, 40′ of the tray member 4 of the second container system 45 slotably interfaces.

Plastic packaging sealing mechanisms generally include snap-fit grips that effectively provide a leak-proof seal that allows the consumer to open, close and releaseably lock the container system multiple times. Some of the advantages of this aspect of the invention are that food freshness can be extended then would otherwise occur without sealing and spillage of the food content is prevented.

Although particular embodiments of the invention have been described in detail for purposes of illustration, various modifications and enhancements may be made without departing from the spirit and scope of the invention. Accordingly, the invention is not to be limited except as by the appended claims.

We claim:

1-22. (canceled)

23. A container system suitable for heated food comprising:
a tray member;
a lid member; and
recessed venting means in the lid member to enable the release of heated gases.

24. The claim as in claim 23 wherein the recessed vent means comprises a flap.

25. The claim as in claim 23 wherein the lid member is releaseably lockable to the tray member.

26. The claim as in claim 25 wherein the releaseably lockable mechanism is a snap-fit grip.

27. The claim as in claim 26, wherein the snap-fit grip lid member component of the snap-fit grip is in mechanical contact with the tray member component of the snap-fit grip in at least four locations.

28. The claim as in claim 26 wherein the angle between the two opposing sides of the tray member component of the snap-fit grip is not less than 4 degrees.

29. The claim as in claim 26, wherein the exterior edge of the snap-fit grip is vertical displaced above from the interior edge of the snap-fit grip.

30. The claim as in claim 29, wherein the vertical displacement is not less then 3/16 inches.

31. A container system suitable for heated food comprising:
a lid member; and
a tray member, the tray member further including handholds at opposing ends of the container system to facilitate the handling and transportation of the food container system.

32. The claim as in claims 23 or 31 wherein the material of the lid and tray members is Polystyrene, Polypropylene, Polyethylene Terephthalate, Polylactide, Polyvinyl Chloride, or other rigid polymers.

33. The claim as in claims 23 or 31 wherein the lid member or tray member is constructed using a process taken from the group consisting of thermoforming, injection molding, transfer molding and blow molding.

34. The claim as in claims 23 or 31 wherein the releaseably lockable mechanism includes tamper-evident, tamper-resistant features.

35. The container system in claims 23 or 31 wherein the lid member has a planar surface.

36. The claim as in claim 23 or 31 wherein the top lid member and tray member are hingeably attached to each other.

37. The claim as in claims 23 or 31, wherein the container system is circular, rectangular, square, other polygonal shape or elliptical.

38. The claim as in claims 23 or 31 wherein the container system is stackable.

39. The claim as in claim 38 wherein stacking is achieved by forming the top lid member with either raised male ribs or female grooves that slotably interfaces with complementary female grooves or male ribs in the bottom of the tray member.

40. The claim as in claims 23 or 31, further comprising raised retaining rib means to restrict movement of the container system contents.

41. The claim as in claims 40 wherein the raised retaining rib is not less than 0.25 inches in height.

42. The claim as in claims 23 or 31 wherein the base of the tray member is sloped downward toward the center of the tray center.

43. The claim as in claim 42 wherein slope angle is not less than 2 degrees from the horizontal plane.

44. A container system suitable for heated food comprising:
a lid member;
a tray member, the tray member further comprising handholds at opposing ends of the tray member, the handholds further comprising of extended flange lips and a raised rib.
